(19) United States
(12) Patent Application Publication
(10) Pub. No.: US 2025/0268310 A1
(43) Pub. Date: Aug. 28, 2025

(54) AEROSOL PROVISION SYSTEM AND METHOD

(71) Applicant: NICOVENTURES TRADING LIMITED, London (GB)

(72) Inventors: Keith CHURCHES, London (GB); Ugurhan YILMAZ, London (GB)

(21) Appl. No.: 18/858,114

(22) PCT Filed: Apr. 18, 2023
(86) PCT No.: PCT/GB2023/051017

§ 371 Date: Oct. 18, 2024

(30) Foreign Application Priority Data
Apr. 20, 2022 (GB) 2205739.2

(51) Int. Cl. A24F 40/60; A24F 40/65; G06F 3/01; G09G 5/10; H04R 1/02; H04R 3/00

(52) U.S. Cl. CPC A24F 40/60; A24F 40/65; G06F 3/016; G09G 5/10; H04R 1/028; H04R 3/00; G09G 2320/0626; H04R 2430/01

(57) ABSTRACT

An aerosol provision system comprising a haptic component and control circuitry. The control circuitry is configured to determine a characteristic of an environment around the aerosol provision system, and adjust a setting of the haptic component based on the determined characteristic.

### TECHNICAL FIELD

The present invention relates to an aerosol provision system and method.

### BACKGROUND

Electronic aerosol provision systems such as electronic cigarettes (e-cigarettes) generally contain an aerosol-generating material, such as a reservoir of a source liquid containing a formulation, typically including nicotine, or a solid material such as a tobacco-based product, from which an aerosol is generated for inhalation by a user, for example through heat vaporisation. Thus, an aerosol provision system will typically comprise an aerosol generator, e.g. a heating element, arranged to aerosolise a portion of aerosol-generating material to generate an aerosol in an aerosol generation region of an air channel through the aerosol provision system. As a user inhales on the device and electrical power is supplied to the aerosol generator, air is drawn into the device through one or more inlet holes and along the air channel to the aerosol generation region, where the air mixes with the vaporised aerosol generator and forms a condensation aerosol. The air drawn through the aerosol generation region continues along the air channel to a mouthpiece, carrying some of the aerosol with it, and out through the mouthpiece for inhalation by the user.

It is common for aerosol provision systems to comprise a modular assembly, often having two main functional parts, namely an aerosol provision device and an article. Typically, the article will comprise the article aerosol-generating material and the aerosol generator (heating element), while the aerosol provision device part will comprise longer-life items, such as a rechargeable battery, device control circuitry and user interface features. The aerosol provision device may also be referred to as a reusable part or battery section and the article may also be referred to as a consumable, disposable/replaceable part, cartridge or cartomiser.

The aerosol provision device and article are mechanically coupled together at an interface for use, for example using a screw thread, bayonet, latched or friction fit fixing. When the aerosol-generating material in an article has been exhausted, or the user wishes to switch to a different article having a different aerosol-generating material, the article may be removed from the aerosol provision device and a replacement article may be attached to the device in its place.

Haptic components or elements can form a part of the aerosol provision system and be used to provide a sensory signal or sensation to the user. Determining how and when to provide such a signal such that the user is able to detect and interpret/understand the signal can be challenging.

Various approaches are described herein which seek to help address or mitigate some of the issues discussed above.

### SUMMARY

The disclosure is defined in the appended claims.

In accordance with some embodiments described herein, there is provided an aerosol provision system comprising a haptic component and control circuitry. The control circuitry is configured to determine a characteristic of an environment around the aerosol provision system, and adjust a setting of the haptic component based on the determined characteristic.

The aerosol provision system can further comprise one or more sensors, and wherein the control circuitry is configured determine the inhalation is about to occur based on signals received from one or more sensors. One of the sensors can be configured to detect if the aerosol generating system is connected to an external power source. One of the sensors can be configured to measure ambient noise around the aerosol provision system. One of the sensors can be configured to measure ambient light around the aerosol provision system. One of the sensors can be configured to measure an orientation and/or movement of the aerosol provision system. One of the sensors can be configured to detect if the user is touching or in proximity of the aerosol provision system.

The aerosol provision system can further comprise a communications interface configured to communicate with one or more other aerosol provision systems or remote devices communicatively coupled to one or more other aerosol provision systems, wherein the control circuitry is further configured to determine the characteristic based on a number of other aerosol provision systems or remote devices communicatively coupled to one or more other aerosol provision systems in communication with the aerosol provision system. The control circuitry can be configured to determine the number of other aerosol provision systems in communication with the aerosol provision system based on a number of unique identifiers in signals received by the communications interface. The communications interface can be configured to communicate with the one or more other aerosol provision systems or remote devices communicatively coupled to one or more other aerosol provision systems using Bluetooth.

Adjusting the setting of the haptic component can correspond to disabling the haptic component.

The setting can be an amplitude and/or frequency of a vibration generated by the haptic component. The setting can be a magnitude of a force generated by the haptic component.

The aerosol provision system can further comprise a display component, and the control circuitry is further configured to adjust a setting of the display component based on the determined orientation. The setting can be a brightness of the display component. Adjusting the setting of the display component can correspond to disabling the display component.

The aerosol provision system can further comprise a speaker component, and the control circuitry is further configured to adjust a setting of the speaker component based on the determined orientation. The setting can be a volume of the speaker component. Adjusting the setting of the speaker component can correspond to disabling the speaker component.

The aerosol provision system can further comprise a communications interface, and wherein control circuitry is further configured to adjust a setting of the haptic component based on a signal received via the communications interface from an external device.

The aerosol provision system can further comprise an input device, and wherein control circuitry is further configured to adjust a setting of the haptic component based on an input received via the input device.

In accordance with some embodiments described herein, there is provided an aerosol provision device for an aerosol provision system, the aerosol provision system comprising a haptic component, wherein the aerosol provision device comprises control circuitry configured to determine a characteristic of an environment around the aerosol provision system, and adjust a setting of the haptic component based on the determined characteristic.

In accordance with some embodiments described herein, there is provided a method for operating an aerosol provision system comprising determining a characteristic of an environment around the aerosol provision system, and adjusting a setting of a haptic component of the aerosol provision system based on the determined characteristic.

There is also provided a computer readable storage medium comprising instructions which, when executed by a processor, performs the above method.

These aspects and other aspects will be apparent from the following detailed description. In this regard, particular sections of the description are not to be read in isolation from other sections.

### BRIEF DESCRIPTION OF DRAWINGS

Embodiments of the invention will now be described, by way of example only, with reference to accompanying drawings, in which:

FIG. 1 is a schematic diagram of an aerosol provision system;

FIG. 2 is a flow diagram of a method for operating an aerosol provision system.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of articles and systems discussed herein which are not described in detail may be implemented in accordance with any conventional techniques for implementing such aspects and features.

The present disclosure relates to aerosol provision systems, which may also be referred to as vapour provision systems, such as e-cigarettes. Throughout the following description the term “e-cigarette” or “electronic cigarette” may sometimes be used, but it will be appreciated this term may be used interchangeably with aerosol provision system and electronic aerosol provision system.

As noted above, aerosol provision systems (e-cigarettes) often comprise a modular assembly including both a reusable part (aerosol provision device) and a replaceable (disposable) or refillable cartridge part, referred to as an article. Systems conforming to this type of two-part modular configuration may generally be referred to as two-part systems or devices. It is also common for electronic cigarettes to have a generally elongate shape. For the sake of providing a concrete example, certain embodiments of the disclosure described herein comprise this kind of generally elongate two-part system employing refillable cartridges. However, it will be appreciated the underlying principles described herein may equally be adopted for other electronic cigarette configurations, for example modular systems comprising more than two parts, as devices conforming to other overall shapes, for up example based on so-called box-mod high performance devices that typically have a more boxy shape, or even systems comprising one part where the aerosol provision device and article are integrally formed with one another.

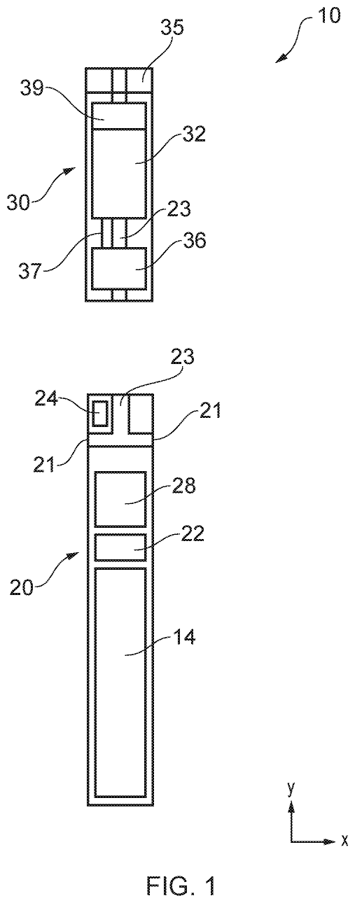

FIG. 1 is a highly schematic diagram (not to scale) of an example aerosol provision system 10, such as an e-cigarette, to which embodiments are applicable. The aerosol provision system 10 has a generally cylindrical shape, extending along a longitudinal or y axis as indicated by the axes (although aspects of the invention are applicable to e-cigarettes configured in other shapes and arrangements), and comprises two main components, namely an aerosol provision device 20 and an article 30.

The article 30 comprises or consists of aerosol-generating material 32, part or all of which is intended to be consumed during use by a user. An article 30 may comprise one or more other components, such as an aerosol-generating material storage area 39, an aerosol-generating material transfer component 37, an aerosol generation area, a housing, a wrapper, a mouthpiece 35, a filter and/or an aerosol-modifying agent.

An article 30 may also comprise an aerosol generator 36, such as a heating element, that emits heat to cause the aerosol-generating material 32 to generate aerosol in use. The aerosol generator 36 may, for example, comprise combustible material, a material heatable by electrical conduction, or a susceptor. It should be noted that it is possible for the aerosol generator 36 to be part of the aerosol provision device 20 and the article 30 then may comprise the aerosol-generating material storage area 39 for the aerosol-generating material 32 such that, when the article 30 is coupled with the aerosol provision device 20, the aerosol-generating material 32 can be transferred to the aerosol generator 36 in the aerosol provision device 20. It should be appreciated that the aerosol generator 36 may encompass an aerosol generator other than a heater. More generally, an aerosol generator is an apparatus configured to cause aerosol to be generated from the aerosol-generating material. In some other embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

Aerosol-generating material is a material that is capable of generating aerosol, for example when heated, irradiated or energized in any other way. The aerosol-generating material 32 may, for example, be in the form of a solid, liquid or gel which may or may not contain an active substance and/or flavourants. In some embodiments, the aerosol-generating material 32 may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material 32 may for example comprise from about 50 wt %, 60 wt% or 70 wt % of amorphous solid, to about 90 wt %, 95 wt% or 100 wt % of amorphous solid.

The aerosol-generating material comprises one or more ingredients, such as one or more active substances and/or flavourants, one or more aerosol-former materials, and optionally one or more other functional materials such as pH regulators, colouring agents, preservatives, binders, fillers, stabilizers, and/or antioxidants.

The active substance as used herein may be a physiologically active material, which is a material intended to achieve or enhance a physiological response. The active substance may for example be selected from nutraceuticals, nootropics, and psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

The aerosol provision device 20 includes a power source 14, such as a battery, configured to supply electrical power to the aerosol generator 36. The power source 14 in this example is rechargeable and may be of a conventional type, for example of the kind normally used in electronic cigarettes and other applications requiring provision of relatively high currents over relatively short periods. The power source 14 may be recharged through the charging port (not illustrated), which may, for example, comprise a USB connector.

The aerosol provision device 20 includes device control circuitry 28 configured to control the operation of the aerosol provision system 10 and provide conventional operating functions in line with the established techniques for controlling aerosol provision systems such as electronic cigarettes. The device control circuitry (processor circuitry) 28 may be considered to logically comprise various sub-units/circuitry elements associated with different aspects of the electronic cigarette's operation. For example, depending on the functionality provided in different implementations, the (device) control circuitry 28 may comprise power source control circuitry for controlling the supply of electrical power from the power source 14 to the aerosol generator 36, user programming circuitry for establishing configuration settings (e.g. user-defined power settings) in response to user input, as well as other functional units/circuitry associated functionality in accordance with the principles described herein and conventional operating aspects of electronic cigarettes. It will be appreciated the functionality of the (device) control circuitry 28 can be provided in various different ways, for example using one or more suitably programmed programmable computer(s) and/or one or more suitably configured application-specific integrated circuit(s)/circuitry/chip(s)/chipset(s) configured to provide the desired functionality.

The aerosol provision device 20 has an interface configured to receive the article 30, thereby facilitating the coupling between the aerosol provision device 20 and the article 30. The interface is located on a surface of the aerosol provision device 20.

The housing of the article 30 has a surface configured to be received by the interface on the aerosol provision device 20 in order to facilitate coupling between the article 30 and the aerosol provision device 20. The surface of the article may be configured to be a size and/or shape that mirrors the size and/or shape of the interface in order to facilitate coupling between the aerosol provision device 20 and the article 30. For example, the interface may comprise a cavity, chamber or other space on the surface of the aerosol provision device 20. The surface of the article 30 can then be configured to be a size and shape that mirrors the size and shape of the cavity in order for the surface of the article 30 to be inserted into the cavity.

Although not illustrated, the interface of the aerosol provision device 20 and the surface of the article 30 may have complementary features to reversibly attach and mate the article 30 to the aerosol provision device 20, such as a screw thread, bayonet fitting, latched or friction fit fixing or other fastening means.

The interface also comprises one or more connectors, such as contact electrodes, connected via electrical wiring to the control circuitry 28 and the power source 14. The article 30 also comprises one or more connectors, such as contact electrodes, connected via electrical wiring to the aerosol generator 36. In use, the article 30 is received by the interface of the aerosol provision device 20, thereby coupling the aerosol provision device 20 and the article 30. This results in the connectors on the article 30 mating with the connectors on the aerosol provision device 20, thereby allowing electrical power and electrical current to be supplied from the power source 14 of the aerosol provision device 20 to the aerosol generator 36 of the article 30.

The housing of the article 30 has a surface configured to engage with an interface on the aerosol provision device 20 in order to facilitate coupling between the article 30 and the aerosol provision device 20. In other words, the aerosol provision device 20 is configured to receive the article 30, via the interface, and the surface of the article is proximate to the interface on the aerosol provision device 20 when the article 20 is received by the interface.

The aerosol provision system 10 includes one or more air inlets 21, located on one or more of the aerosol provision device 20 and the article 30. In use, as a user inhales on the mouthpiece 35, air is drawn into the aerosol provision system 10 through the air inlets 21 and along an air channel 23 to the aerosol generator 36, where the air mixes with the vaporised aerosol-generating material 32 and forms a condensation aerosol. The air drawn through the aerosol generator 36 continues along the air channel 23 to a mouthpiece 35, carrying some of the aerosol with it, and out through the mouthpiece 35 for inhalation by the user.

By way of a concrete example, the article 30 comprises a housing (formed, e.g., from a plastics material), an aerosol-generating material storage area 39 formed within the housing for containing the aerosol-generating material 32 (which in this example may be a liquid which may or may not contain nicotine), an aerosol-generating material transfer component 37 (which in this example is a wick formed of e.g., glass or cotton fibres, or a ceramic material configured to transport the liquid from the reservoir using capillary action), an aerosol-generating area containing the aerosol generator 36, and a mouthpiece 35. Although not shown, a filter and/or aerosol modifying agent (such as a flavour imparting material) may be located in, or in proximity to, the mouthpiece 35. The aerosol generator 36 of this example comprises a heater element formed from an electrically resistive material (such as NiCr8020) spirally wrapped around the aerosol-generating material transfer component 37, and located in an air channel 23. The area around the heating element and wick combination is the aerosol-generating area of the article 30.

As illustrated in FIG. 1, the aerosol provision system 10 also comprises a haptic component 22. The haptic component 22 is configured to generate one or more vibrations and/or forces in order to provide a haptic sensation to the user of the aerosol provision system 10. The haptic component 22 can comprise any suitable component configured to provide a haptic sensation (feedback) to a user. For example, the haptic component 22 may comprise an eccentric rotating mass (ERM) or linear resonant actuator (LRA) haptic component. The haptic component 22 may comprise a piezoelectric actuator configured to produce one more vibrations, and/or the haptic component 22 can comprise a motor configured to produce one or more forces. For example, a pneumatic motor, valve and/or fan can be used to generate a puff, pulse or other movement of air that may be sensed by the user of the aerosol provision system 10. Additionally, or alternatively, the haptic component 22 may generate haptic sensations that do not directly result from a motion (e.g., vibration) of a mass or of air; e.g., the haptic component 22 may be configured to generate a haptic sensation via an electromagnetic field or via an electric pulse, for example.

The haptic component 22 can be located on or within the aerosol provision device 20 and/or the article 30. For example, the haptic component 22 can be located proximate to or forming part of the housing of the aerosol provision device 20 such that the vibrations and/or forces generated by the haptic component 22 can be felt by the user of the aerosol provision system 10 when the user of the aerosol provision system 10 is holding the aerosol provision device 20. The aerosol provision system 10 may comprise more than one haptic component 22, for example one located proximate to or forming part of the housing of the aerosol provision device 20 and one located proximate to or forming part of the article 30, such as on the mouthpiece 35 such that the vibrations/forces generated by the haptic component 22 are sensed on the lips of the user during an inhalation.

The haptic component 22 is operatively coupled to the power source 14 of the aerosol provision device 20 in order to receive electrical power, and the haptic component 22 is operatively coupled to the control circuitry 28 such that the control circuitry 28 can be configured to control the haptic component 22.

The control circuitry 28 is configured to adjust a setting of the haptic component 22 in response to determining a characteristic of an environment around the aerosol provision system 10. In other words, the control circuitry 28 is configured to determine a characteristic of an environment around the aerosol provision system 10, and then adjust a setting of the haptic component based on the determined characteristic.

It will be understood that the environment around the aerosol provision system 10 corresponds to the region (area/volume), people and objects proximate to or within a given radius, such as 1, 5, 10 or 20 m of the aerosol provision system 10. The characteristic of the environment around the aerosol provision system 10 corresponds to a property or combination of properties of the environment, such as a temperature and/or air pressure of the environment (e.g., an ambient temperature and/or air pressure), location of the environment (for example the GPS location of the aerosol provision system 10), amount of light, amount of noise and/or number of people in the environment or any other measurable or derivable property of the environment.

The control circuitry 28 can be configured to determine the characteristic of the environment around the aerosol provision system 10 based on signals received from one or more sensors. The aerosol provision system 10 illustrated in FIG. 1 comprises one or more sensors 24. The one or more sensors 24 can be located on or within the aerosol provision device 20 and/or the article 30. The one or more sensors 24 can be operatively coupled to the power source 14 of the aerosol provision device 20 in order to receive electrical power, and the one or more sensors 24 can be operatively coupled to the control circuitry 28 such that the control circuitry 28 can be configured to control the one or more sensors 24. The control circuity 28 is then configured to determine the characteristic of the environment around the aerosol provision system 10 based on signals received from the one or more sensors. In other words, the control circuit 28 is configured to read or otherwise receive readings from the one or more sensors 24, and use the readings to determine the characteristic of the environment around the aerosol provision system 10. The control circuitry 28 can receive readings from the sensors 24 periodically, for example every second, minute or five minutes, or the control circuitry 28 can send a request to the sensors 24 for the one or more readings. Equally, the control circuitry 28 can be configured to determine the characteristic of the environment around the aerosol provision system 10 in response to an event, for example one or more readings from the sensors 24 changing.

One of the sensors can be configured to detect if the aerosol generating system is connected to an external power source. For example, one of the sensors 24 can comprise a current sensor configured to measure an amount of current received from an external power supply. When the power source or battery 14 of the aerosol provision system 10 needs to be recharged, the aerosol provision system 10 can be connected to an external power supply in order to recharge the power source or battery 14. The current sensor can be located between the power source 14 and charging port of the aerosol provision system 10 in order to measure current flow between the external power supply and the power source 14 (i.e. to measure or otherwise detect when the aerosol provision system 10 is connected to an external power supply).

One of the sensors 24 can be configured to measure ambient noise around the aerosol provision system 10 (i.e. in the environment around the aerosol provision system 10). For example, one of the sensors 24 can comprise microphone configured to measure the amount of noise proximate to the aerosol provision system 10. Equally, the microphone or other noise sensor could be located proximate to the air inlets 21 and/or air channel 23 in order to detect noise associated with the flow of air into and through the air channel 23.

One of the sensors 24 can be configured to measure ambient light around the aerosol provision system (i.e. in the environment around the aerosol provision system 10). For example, one of the sensors 24 can comprise an optical sensor configured to measure the amount of light proximate to the aerosol provision system 10. When the aerosol provision system 10 is located in direct sunlight, the amount of light proximate to the aerosol provision system 10 and detected by the optical sensor will be high, as opposed to when the aerosol provision system 10 is located in a dark room, cupboard, drawer or other enclosed space. Equally, when the user is holding the aerosol provision system 10 and about to inhale on the aerosol provision system 10, the user's hand, lips or other part of the user's body may partially or completely obscure the optical sensor, thereby reducing the amount of light proximate to the aerosol provision system and detected by the optical sensors. The optical sensor can be located on a portion of the aerosol provision system 10, such as the body of the aerosol provision device 20, where a user typically holds the aerosol provision system 10 such that the amount of light detected by the optical sensors is indicative of whether or not the user is holding the aerosol provision system 10.

One of the sensors 24 can be configured to detect if the user is touching the aerosol provision system. For example, one of the sensors 24 can comprise a capacitive sensor, pressure sensor or other form of touch sensor. Such a touch sensor can be located on the body of the aerosol provision system 10, for example on the aerosol provision device 20, in order to detect if the user is holding or otherwise touching the aerosol provision system 10 with their hand. Equally, as described above, the aerosol provision system 10 can comprise a mouthpiece 35, and the one of the sensor 24 can be configured to detect if the user is touching the mouthpiece 35. For example, one of the sensors 24 a touch sensor located on the mouthpiece 35 and configured to detect if the user is touching the mouthpiece (e.g. with their lips or other part of their mouth).

One of the sensors 24 can be configured to measure an orientation and/or movement of the aerosol provision system 10. For example, one of the sensors 24 can comprise a gyroscope, such as a microelectromechanical systems (MEMS) gyroscope or gyrometer, a 6 or 9 axis accelerometer, a MEMS accelerometer and/or an Inertial Measurement Unit (IMU). The orientation of the aerosol provision system 10 measured by the accelerometer can indicate whether the aerosol provision system 10 is located on a horizontal flat surface (i.e. along the x-axis in FIG. 1), or whether the aerosol provision system 10 is in a different orientation such as with the article 30 pointing substantially downwards orientation (i.e. with the mouthpiece 35 being at the lowest point on the aerosol provision system 10, in opposite orientation in the y-direction to that illustrated in FIG. 1). The accelerometer can also be configured to measure the motion of the aerosol provision system 10, and therefore detect whether the aerosol provision system 10 is stationary, moving at a constant velocity, or undergoing an acceleration or deceleration.

The control circuitry 28 can also be configured to determine a characteristic of the environment around aerosol provision system 10 based on a number of other aerosol provision systems in communication with the aerosol provision system. For example, the aerosol provision system 10 can comprise a communications interface configured to communicate with one or more other aerosol provision systems or remote devices communicatively coupled to one or more other aerosol provision systems, for example via a wireless communications network. The communications interface can be operatively coupled to the control circuitry 28 such that the control circuitry 28 can communicate with the one or more other aerosol provision systems by controlling the communications interface.

The communications interface can be configured to communicate using a suitable wireless communications protocol such as Wi-Fi, Bluetooth, RFID, NFC. The control circuitry 28 can then be configured to determine the characteristic of the environment around aerosol provision system 10 based on the number of the one or more other aerosol provision systems that are in communication with the aerosol provision system 10 (i.e. in communication with the communications interface). For example, if the aerosol provision system (i.e. the communications interface) is not in communication with any other aerosol provision system and/or remote device communicatively coupled to one or more other aerosol provision systems, the control circuitry 28 can determine that there are no other aerosol provision systems proximate to the user and the aerosol provision system 10, in particular if the communications interface is configured to communicate using a short range suitable wireless communications protocol such as Bluetooth, RFID, or NFC. Equally, if the aerosol provision system (i.e. the communications interface) is in communication with a large number of other aerosol provision system and/or remote devices communicatively coupled to one or more other aerosol provision systems, such as 10, 20 or 50, the control circuitry 28 can determine that the user may be located in a crowded area, such as at a mass gathering, on public transport or in a designated smoking location.

The number of other aerosol provision systems and/or remote devices communicatively coupled to one or more other aerosol provision systems in communication with the aerosol provision system 10 can be based on a number of unique identifiers in signals received by the communications interface. For example, each aerosol provision system and remote device can have or be allocated a unique identifier that can be added or otherwise appended to packets or signals sent from that aerosol provision system. As such packets or signals are received by the communications interface, the control circuitry 28 and/or the communications interface can read the identifier from each packet/signal and determine the number of unique identifiers in the received signals. It will be appreciated that the number of unique identifiers corresponds to the number of other aerosol provision systems and/or remote devices communicatively coupled to one or more other aerosol provision systems that are in communication with the aerosol provision system 10. The remote device may be allocated a unique identifier itself, or the remote device may send the unique identifier of the one or more other aerosol provision systems the remote device is communicatively coupled to in the packets received by the communications interface.

Alternatively, or in addition, the number of other aerosol provision systems in communication with the aerosol provision system 10 can correspond to the number of other aerosol provision systems within communication range of the aerosol provision system 10. As it will be appreciated, each wireless communication protocol has a finite range or distance over which signals can be sent. The number of aerosol provision systems within communication range of the aerosol provision system 10 (and therefore number of other aerosol provision systems in communication with the aerosol provision system 10) can correspond to the number of aerosol provision system 10 from which advertising packets or signals have been received by the communications interface.

The number of other aerosol provision systems in communication with the aerosol provision system 10 can be updated periodically, for example every 1, 5 or 10 minutes, or can be updated dynamically.

In response to determining the characteristic of the environment around the aerosol provision system 10, such as based on signals received from one or more sensors 24 and/or a number of other aerosol provision systems in communication with the aerosol provision system 10 as described above, the control circuitry 28 is configured to adjust a setting of the haptic component 22. The setting can be one or more of a duration, magnitude, amplitude, frequency and/or pattern of the one or more vibrations or forces generated by the haptic component. For example, the setting can be an amplitude and/or frequency of a vibration generated by the haptic component. Equally, the setting can be a duration and/or magnitude of a force generated by the haptic component.

For example, if the signals received from the one or more sensors indicate a low level of ambient light and noise, the aerosol provision system 10 is stationary, the user is not touching the aerosol provision system 10 and that the aerosol provision system 10 is connected to an external power supply, the control circuitry 28 can determine that the aerosol provision system 10 is likely in a dark area with nobody around/proximate to the aerosol provision system 10. In this case, the haptic component 22 may not be required, as the user of the aerosol provision system 10 is unlikely to detect the vibrations/forces generated by the haptic component. The control circuitry 28 can then alter a setting of the haptic component by disabling the haptic component 22.

Equally, if the signals received from the one or more sensors indicate a low level of ambient light but a high level of ambient noise, the aerosol provision system 10 is moving but its orientation is relatively static, e.g., orientated substantially vertically (i.e. with the mouthpiece at the highest or lowest point on the aerosol provision system 10), and that the aerosol provision system 10 is not connected to an external power supply, the control circuitry 28 can determine that the aerosol provision system 10 likely in a dark area proximate to the user of the aerosol provision system 10, for example in a bag or pocket of the user. In this case, vibrations/forces generated by the haptic component 22 may be detected by the user, but the amplitude/magnitude of the vibrations/forces generated by the haptic component 22 may need to be increased in order to ensure the user can detect them. The control circuitry 28 can then alter a setting of the haptic component by increasing the amplitude/magnitude of the vibrations/forces generated by the haptic component 22.

As set out above, if the aerosol provision system (i.e. the communications interface) is in communication with a large number of other aerosol provision system, such as 10, 20 or 50, the control circuitry 28 can determine that the user may be located in a crowded area, such as at a mass gathering, on public transport or in a designated smoking location. In this case, the vibrations/forces generated by the haptic component 22 may be detected by the user, but the amplitude/magnitude of the vibrations/forces generated by the haptic component 22 may need to be increased in order to ensure the user can detect them. The control circuitry 28 can then alter a setting of the haptic component by increasing the amplitude/magnitude of the vibrations/forces generated by the haptic component 22.

Adjusting the setting of the haptic component 22 can also correspond to disabling the haptic component 22. In other words, in response to determining the characteristic of the environment around the aerosol provision system 10, the control circuitry 28 can be configured to disable the haptic component 22. For example, the control circuitry 28 can be configured to prevent the supply of electrical power from the power source 14 to the haptic component 22. Equally, adjusting the setting of the haptic component 22 can also correspond to enabling the haptic component 22, for example by allowing or otherwise enabling the supply of electrical power from the power source 14 to haptic component 22.

Hence it should be appreciated that a setting of the haptic component 22 may be adjusted based on the signals received by one or more sensors 24 and that how the setting of the haptic component 22 is adjusted may correspond to a particular scenario. As stated, the setting may be adjusted based on signals from any one or more of the sensors 24. In some implementations, adjustment of the setting may be based on any one of the signals from the sensor surpassing or falling below a threshold. In other implementations, adjustment of the setting may be based on a likelihood (or weighting) of one or more of the signals from the sensors 24 indicating a particular scenario, such as those signified above.

By way of example only, the setting of the haptic component 22 may be set as follows in response to output from the sensors 24.
when the sensor(s) determine the aerosol generating system is coupled to an external power source, the haptic component 22 may be disabled or the relative strength of the haptic component 22 may be decreased;
when the sensor(s) determine the aerosol generating system is in a noisy environment, the haptic component 22 may be enabled or the relative strength of the haptic component 22 may be increased;
when the sensor(s) determine the aerosol generating system is in a dark environment, the haptic component 22 may be enabled or the relative strength of the haptic component 22 may be increased;
when the sensor(s) determine that a user is touching and/or in proximity of the aerosol provision system, the haptic component 22 may be enabled or the relative strength of the haptic component 22 may be increased;
when the sensor(s) determine the aerosol generating system is stationary (or stationary for a length of time), the haptic component 22 may be disabled or the relative strength of the haptic component 22 may be decreased;
when the sensor(s) determine the aerosol generating system is in a horizontal orientation (or in this orientation for a length of time), the haptic component 22 may be disabled or the relative strength of the haptic component 22 may be decreased; and
when the control circuitry determines the aerosol generating system is in proximity of one or more other aerosol generating systems, the haptic component 22 may be disabled or the relative strength of the haptic component 22 may be decreased.

It should be appreciated that the above is given as an example and in other implementations, the setting of the haptic component 22 may be varied in a different manner (i.e., opposite to the above). It should also be appreciated that above is described, generally, in respect of a binary determination as to whether a particular condition is met; however, it should be appreciated that in other implementations the setting of the haptic component 22 may be adjusted in proportion to the signal output from the sensor(s).

Additionally, in some implementations, combinations of the above may be used to adjust the setting of the haptic component 22. For example, if the system 10 is determined to be static, a dark and quiet environment (which may be indicative of the user being in a cinema or theatre for example), the setting of the haptic component may be set to be disabled or the strength thereof may be set to be relatively weaker. This may be based on taking an average or combined effect of the various actions attributed to these three separate conditions (e.g., when static and in a quiet environment, the above suggests the haptic component may be disabled/set to be relative weaker, while for a dark environment, the above suggests the haptic component may be enabled/set relatively stronger—as there are two conditions met for disabling/setting the haptic component to be relatively weaker versus one condition met for enabling/setting the haptic component to be relatively stronger, the latter setting is selected).

Additionally, and in accordance with the above, it should be understood that combinations of outputs from the sensor(s) may be given different weighting in determining how to adjust the setting of the haptic component 22. For example, the above describes that the haptic component 22 is disabled or the relative strength decreased when the sensor(s) indicate the system 10 is stationary, and separately that the haptic component 22 is enabled or the relative strength increased when the sensor(s) indicate the system 10 is in a dark environment. However, in situations where the system is both static and in a dark environment, it may be the determination that the system is static that takes precedence; hence, the haptic component 22 is disabled or the relative strength decreased. For example, this may indicate the system 10 is stored and therefore does not need to provide haptic feedback to a user. It should be appreciated that setting may be adjusted based on the output from several sensors and the action taken in respect of the setting may be adjusted accordingly.

Although not illustrated in FIG. 1, the aerosol provision system 10 may comprise one or more output components, such as a display component and/or a speaker component. The control circuitry 28 can be configured to adjust a setting of the display component and/or the speaker component in response to determining the characteristic of the environment around the aerosol provision system 10.

In the case of the display component, the setting of the display component can correspond to a brightness, contrast, colour balance or other visual property of the display component (i.e. the screen of the display component). In the case of the speaker component, the setting of the speaker component can correspond to a volume, balance or other auditory property of the speaker component. Equally, adjusting the setting of the display device and/or speaker component can correspond, respectively, to enabling or disabling the display component and/or speaker component. Adjusting the setting of the display component and/or the speaker component could occur substantially simultaneously with adjusting the setting of the haptic component 22, or in response to adjusting the setting of the haptic component 22. For example, the control circuitry 22 could be configured to adjust the brightness of the display component (e.g. lower the brightness) and/or adjust the volume of the speaker component (e.g. lower the volume) in response to enabling the haptic component 22. Equally, the control circuitry 22 could be configured to disable the display component and/or the speaker component when the haptic component 22 is enabled, then enable the display component and/or the speaker component when the haptic component 22 is disabled. This allows a primary component for conveying signals to the user to be changed between the one or more output components and the haptic component 22.

For example, if the signals received from the one or more sensors indicate a high level of ambient noise and that the user is touching the aerosol provision system 10, the control circuitry 28 can determine that the user is holding the aerosol provision system 10, but that they are in a noisy environment. Alternatively, or in addition, the aerosol provision system 10 (i.e. the communications interface) may be in communication with a large number of other aerosol provision system, such as 10, 20 or 50, indicating that the user may be located in a crowded area. In these cases, noise generated by the speaker component is unlikely to be heard by the user or could disturb other people, but the vibrations/forces generated by the haptic component 22 are likely to be detected by the user and not disturb other people. The control circuitry 28 can then alter a setting of the haptic component by increasing the amplitude/magnitude of the vibrations/forces generated by the haptic component 22 whilst altering a setting of the speaker component by decreasing the volume of the speaker component. Alternatively, the control circuitry 28 can alter a setting of the haptic component by enabling the haptic component 22 whilst alter a setting of the speaker component by disabling the speaker component

Equally, if the signals received from the one or more sensors indicate a low level of ambient noise and that the user is not touching the aerosol provision system 10, and/or the aerosol provision system 10 (i.e. the communications interface) is not in communication with any other aerosol provision system or a small number of other aerosol provision systems, such as 1, 2 or 5, the control circuitry 28 can then alter a setting of the haptic component by decreasing the amplitude/magnitude of the vibrations/forces generated by the haptic component 22 or disabling the haptic component 22, whilst altering a setting of the speaker component by increasing the volume of the speaker component or enabling the speaker component.

As described above, the aerosol provision system 10 can also comprise a communications interface. Alternatively, or in addition to communicating with one or more other aerosol provision systems, the control circuitry 28 can be configured to communicate with one or more external devices, such as a computer, mobile phone or other electronic device, via the communications interface. The communications protocol used to communicate with the one or more other aerosol provision systems may be the same or different to the communications protocol used to communicate with the one or more external devices. For example, the communications interface may be configured to communicate with the one or more other aerosol provision systems and the one or more external devices using Bluetooth, or the communications interface may be configured to communicate with the one or more other aerosol provision systems using NFC and communicate with the one or more external devices using Wi-Fi.

The control circuitry 28 can be configured to adjust a setting of the haptic component 22, such as the settings described above, based on signal received via the communications interface from an external device. In other words, the external device can send a signal to the aerosol provision system 10 via the communications interface, and in response to receiving the signal, the control circuit 28 adjusts a setting of the haptic component 22. This allows the setting of the haptic component 22 to be adjusted without directly attracting the aerosol provision system 10. The signal received from the external device via the communications interface may indicate the setting and/or magnitude or type of adjustment to be made to the setting of the haptic component 22 to be adjusted, or the control circuitry 28 may be configured to determine the setting of haptic component 22 to adjust based on the signal received from the external device.

The aerosol provision system 10 can also comprise an input device, such as a button, switch, or touchscreen display. In the latter case, the display component described above can be a touchscreen component that is also configured to receive touch inputs. The control circuitry can be configured to adjust a setting of the haptic component 22, such as the settings described above, based on an input received via the input device. In other words, the user can provide an input on the input device, and in response to receiving the input, the control circuit 28 adjusts a setting of the haptic component 22. This allows the setting of the haptic component 22 to be adjusted by the user providing an input on the aerosol provision system 10. The input received from the input device (e.g. from the user) may indicate the setting and/or magnitude or type of adjustment to be made to the setting of the haptic component 22 to be adjusted, or the control circuitry 28 may be configured to determine the setting of haptic component 22 to adjust based on the input received from the input device.

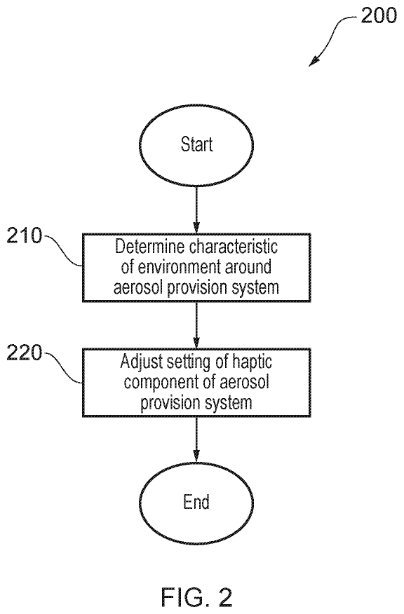

FIG. 2 is a flow diagram of a method 200 for operating an aerosol provision system, such as aerosol provision system 10. The method begins at step 210, a characteristic of an environment around the aerosol provision system is determined. At step 220, a setting of a haptic component of the aerosol provision system is adjusted based on the determined characteristic. The method then ends.

The method 200 illustrated in FIG. 2 may be stored as instructions on a computer readable storage medium, such that when the instructions are executed by a processor, the method described above is performed. The computer readable storage medium may be non-transitory. In other words, the method 200 illustrated in FIG. 2 may be computer implemented. The method 200 may be performed by the aerosol provision device 20, such as by the control circuitry 28.

As described above, the present disclosure relates to (but it not limited to) an aerosol provision system comprising a haptic component and control circuitry. The control circuitry is configured to determine a characteristic of an environment around the aerosol provision system, and adjust a setting of the haptic component based on the determined characteristic.

Thus, there has been described an aerosol provision system and method.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol provision system comprising:
a haptic component; and
control circuitry configured to:
determine a characteristic of an environment around the aerosol provision system; and
adjust a setting of the haptic component based on the determined characteristic.

2. The aerosol provision system of claim 1, further comprising one or more sensors, and wherein the control circuitry is configured to determine the characteristic based on signals received from one or more sensors.

3. The aerosol provision system of claim 2, wherein one of the sensors is configured to detect if the aerosol generating system is connected to an external power source.

4. The aerosol provision system of claim 2, wherein one of the sensors is configured to measure ambient noise around the aerosol provision system.

5. The aerosol provision system of claim 2 4, wherein one of the sensors is configured to measure ambient light around the aerosol provision system.

6. The aerosol provision system of claim 2, wherein one of the sensors is configured to measure an orientation and/or movement of the aerosol provision system.

7. The aerosol provision system of any one of claim 2, wherein one of the sensors is configured to detect if the user is touching or in proximity of the aerosol provision system.

8. The aerosol provision system of claim 2, further comprising a communications interface configured to communicate with one or more other aerosol provision systems or remote devices communicatively coupled to one or more other aerosol provision systems, wherein the control circuitry is further configured to determine the characteristic based on a number of other aerosol provision systems or remote devices communicatively coupled to one or more other aerosol provision systems in communication with the aerosol provision system.

9. (canceled)

10. (canceled)

11. The aerosol provision system of claim 1, wherein adjusting the setting of the haptic component corresponds to disabling the haptic component.

12. The aerosol provision system of claim 1, wherein the setting is an amplitude and/or frequency of a vibration generated by the haptic component.

13. The aerosol provision system of claim 1, wherein the setting is a magnitude of a force generated by the haptic component.

14. The aerosol provision system of claim 1, further comprising a display component, and the control circuitry is further configured to adjust a setting of the display component based on the determined characteristic.

15. The aerosol provision system of claim 14, wherein the setting is a brightness of the display component.

16. (canceled)

17. The aerosol provision system of claim 1, further comprising a speaker component, and the control circuitry is further configured to adjust a setting of the speaker component based on the determined characteristic.

18. The aerosol provision system of claim 17, wherein the setting is a volume of the speaker component.

19. The aerosol provision system of claim 17, wherein adjusting the setting of the speaker component corresponds to disabling the speaker component.

20. The aerosol provision system of claim 1, further comprising a communications interface, and wherein the control circuitry is further configured to adjust a setting of the haptic component based on a signal received via the communications interface from an external device.

21. The aerosol provision system of claim 1, further comprising an input device, and wherein the control circuitry is further configured to adjust a setting of the haptic component based on an input received via the input device.

22. An aerosol provision device for an aerosol provision system, the aerosol provision system comprising a haptic component, wherein the aerosol provision device comprises control circuitry configured to:
determine a characteristic of an environment around the aerosol provision system; and
adjust a setting of the haptic component based on the determined characteristic.

23. A method for operating an aerosol provision system comprising:
determining a characteristic of an environment around the aerosol provision system; and
adjusting a setting of a haptic component of the aerosol provision system based on the determined characteristic.

24. (canceled)
